(19) United States
(12) Patent Application Publication
(10) Pub. No.: US 2013/0052662 A1
(43) Pub. Date: Feb. 28, 2013

(54) Method for Automated Autoantibody Detection and Identification

(71) Applicants: Betsy J. Barnes, West Orange, NJ (US); Di Feng, Kearney, NJ (US); Rivka C. Stone, Passaic, NJ (US)

(72) Inventors: Betsy J. Barnes, West Orange, NJ (US); Di Feng, Kearney, NJ (US); Rivka C. Stone, Passaic, NJ (US)

(73) Assignee: University of Medicine and Dentistry of New Jersey, Somerset, NJ (US)

(21) Appl. No.: 13/592,492

(22) Filed: Aug. 23, 2012

Related U.S. Application Data
(60) Provisional application No. 61/526,447, filed on Aug. 23, 2011.

(51) Int. Cl. G01N 21/64

(52) U.S. Cl. 435/7.21; 435/7.1

(57) ABSTRACT

The present invention is a kit and method for detecting and identifying autoantibodies. The invention employs the use of indirect immunofluorescence, imaging flow cytometry and pattern recognition software to automatically identify autoantibodies associated with autoimmune disorders.

### INTRODUCTION

This application claims priority from U.S. Provisional Application No. 61/526,447, filed Aug. 23, 2011, the content of which is incorporated herein by reference in its entirety.

### BACKGROUND OF THE INVENTION

Antibodies are proteins that are made as part of an immune response. Normally the immune system responds to infection by producing large numbers of antibodies to fight bacteria or viruses. However, when a person has an autoimmune disease, the body's immune system malfunctions, producing large amounts of autoantibodies. Autoantibodies, unlike normal antibodies that fight bacteria, viruses, parasites, and fungi, attack the body's own tissues and cells. Autoantibody-mediated inflammation and cell destruction can affect blood cells, skin, joints, kidneys, lungs, nervous system, and other organs of the body resulting in autoimmune or connective tissue disorders such as systemic lupus erythematosus (SLE), autoimmune hepatitis, rheumatoid arthritis, polymyositis/dermatomyositis, mixed connective tissue disease, Sjogren's syndrome, and systemic sclerosis.

Commercial labs and hospitals have used solid phase immunoassays, such as the ELISA method, for the detection of specific anti-nuclear antibodies (ANAs), thus providing a cheaper and more routine (less subjective) way to assay large volumes of clinical specimens. However, one of the problems with the solid phase immunoassay is that only a limited number of known autoantigens can be measured. For a multiplex platform, this technology only covers 8-10 autoantigens. It has been reported that up to 35% of patients with SLE and a positive ANA-HEp-2 test were negative on solid phase assays (Bonilla, et al. (2007) Clin. Immunol. 124:18-21; Copple, et al. (2007) Ann. NY Acad. Sci. 1109:464-472; Sinclair, et al. (2007) Clin. Lab. 53:183-191).

As an alternative ANA test, indirect immunofluorescence (IIF) staining of human epithelial-2 (HEp-2) cells (ANA-HEp-2 test) can be performed to identify autoantibodies in serum, body fluids or tissues. This allows for the detection of more than 100 clinically relevant autoantibodies generated against cytoplasmic and nuclear antigens in patient serum and has been recommended by the American College of Rheumatology (ACR) ANA Taskforce as the gold standard for ANA test rather than solid phase immunoassay. In brief, HEp-2 cells are incubated with diluted clinical samples and then disease-specific autoantibodies are detected by incubation with fluorescent-conjugated immunoglobulin; distinct staining patterns are determined by visual inspection using a fluorescent microscope, wherein staining patterns define the specific autoantibodies present in a patient's serum. By this method, the identification of serum autoantibodies generally requires manual inspection of HEp-2 cellular staining by a pathologist or trained laboratory technician and is therefore subjective. In this respect, the primary disadvantage of the ANA-HEp-2 test is the subjective evaluation of HEp-2 slides that complicates standardization and reproducibility. Interpretation of immunofluorescence patterns is dependent on the individual's knowledge and experience and therefore high intra- and inter-laboratory variability is common and represents a major diagnostic problem, especially in non-specialized laboratories. Moreover, this method is labor intensive and time consuming for the large quantity of samples that are processed annually. Automated systems have been described (HEp-2 cell analyzer, HEp-2 PAD, and AKLIDES) for slide-based detection of IIF patterns. However, these systems are not widely used.

PCT/DE08/01894 describes a method for the evaluation of end titer in the determination of antibodies against nuclear and cytoplasmic antigens in human sera by means of IIF. Microscope slides, imaging techniques and computer analysis of images are used to conduct the evaluation. However, an automated means of cellular analysis is not described. While, DE 19801400 describes the use of imaging software to disconnect, isolate, and analyze overlapping Hep-2 cells observed in a single field of view, the cells are not sorted by flow cytometry.

### SUMMARY OF THE INVENTION

The present invention features a method for detecting and identifying autoantibodies in a clinical sample. The method of the invention involves the steps of

(a) fixing and permeabilizing a suspension of substrate cells;

(b) incubating a patient sample with the suspension of substrate cells;

(c) incubating the suspension of substrate cells with a fluorescently labeled anti-human antibody;

(d) incubating the substrate cells with a reagent for staining a cellular compartment or marker;

(e) subjecting the substrate cells to imaging flow cytometry to acquire cellular images; and

(f) comparing the images to pre-defined templates with automated pattern recognition.

In some embodiments, the anti-human antibody is an anti-human IgG antibody, anti-human IgA antibody or anti-human IgM antibody. In other embodiments, the substrate cells have been chemically or recombinantly manipulated. In yet further embodiments, the substrate cells are human epithelial-2 (HEp-2) cells. A kit containing fixed HEp-2 cells; one or more reagents for staining a cellular compartment or marker; one or more anti-human antibodies; and automated pattern recognition software for comparing imaging flow cytometry images to pre-defined templates is also provided.

### BRIEF DESCRIPTION OF THE DRAWINGS

FIG. 1 shows examples of different autoantibody binding patterns on HEp-2 cells.

FIG. 2 shows that nuclear localization pattern recognition is not dependent on high fluorescence intensity.

### DETAILED DESCRIPTION OF THE INVENTION

An automated system that objectively determines immunofluorescence patterns on HEp-2 cells has now been developed. The present invention incorporates imaging flow cytometry with automated pattern recognition and interpretation using algorithms and computer software. The process of substrate preparation, staining, and analysis of IIF patterns is optimized and streamlined to allow rapid, accurate detection and identification of autoantibodies in clinical samples to aid in the diagnosis of autoimmune diseases.

Indirect immunofluorescence staining of HEp-2 cells for the detection of autoantibodies in clinical samples is conventionally carried out in three stages: i) incubation of HEp-2 cells on a microscope slide with serially diluted sera from patients, 2) staining of HEp-2 cells on a microscope slide with fluorescein isothiocyanate-conjugated anti-human immunoglobulin (IgG heavy and light chains), and 3) analysis of stained slides with a fluorescence microscope by a Pathologist, trained technician or image acquisition system. Samples are classified as ANA-HEp-2-positive if a well-defined IIF pattern is identified at a 1:80 dilution. ANA titers are determined by testing successive 2-fold dilutions of the serum up to 1:5120.

In stage 1, conventional methods involve growing HEp-2 cells on microscope slides or purchasing pre-made slides of HEp-2 cells. A portion of mitotic cells on each slide is required for detection of certain autoantibodies via analysis of the chromosome region of cells in mitosis. Generally, manufacturers of the pre-made slides guarantee a certain percentage of cells will be mitotic. However, there are limitations at this stage. For example, this is slide-based assay, which limits the number of cells that can be analyzed by the limited number of cells plated on each slide. In addition, the use of pre-made slides, meant to aid in standardization and processing time, eliminates the ability to physiologically manipulate cells prior to staining.

In stage 2, HEp-2 cells are incubated with serially diluted clinical serum samples and anti-human fluorescent-labeled IgG. Conventionally only one fluorescent label (anti-human IgG) is used to detect autoantibodies, creating cytoplasmic and nuclear staining patterns on slides. While additional labels can be used for detection under a fluorescent microscope, the process of image capture and analysis is difficult and time consuming in the context of using microscope slides. Therefore, one key limitation of the conventional technology at this stage is the difficulty in using multiple fluorescent-labeled probes to identify different cell compartments or cells in different stages of the cell cycle for analysis of autoantibodies.

In stage 3, analysis of IIF patterns on HEp-2 slides is conventionally performed by a trained laboratory technician or licensed pathologist. However, this conventional practice is limited in that it is time consuming and a subjective evaluation that complicates the standardized and reproducible evaluation of the ANA HEp-2 test. In addition, interpretation of immunofluorescence patterns is dependent on the individual's knowledge and experience, and therefore high intra- and inter-laboratory variability is common, representing a major diagnostic problem. Furthermore, an accurate determination of IIF patterns requires the presence of cells at different stages of the cell cycle.

While maintaining the traditional three-stage process of ANA testing, the instant method offers significant advantages at each stage. The instant method is high-throughput, eliminates the subjectivity of data interpretation, and uses flow cytometry to more accurately localize and detect staining of autoantibodies. In accordance with the instant method, stage 1 includes fixing and permeabilizing a suspension of HEp-2 cells for staining. Prior to this, cells can be chemically and/or genetically manipulated to enable the specific detection of particular autoantibodies downstream. For example, cells can be treated with colcemid or nocodazole to arrest cells in the mitotic state, thus enabling the detection of autoantibodies to the mitotic apparatus. Cells can be stably transfected with an autoantigen, such as Ro/SSA antigen (Cozzani, et al. (2008) J. Rheumatol. 35:1320-1322), that has low expression in resting HEp-2 cells, thus enhancing sensitivity of detection. At this stage, the instant method offers several advantages. For example, because the instant method is not slide-based, the method is not limited by insufficient cell numbers on a given slide or the number of cells in the mitotic stage to be able to accurately determine IIF patterns. In addition, if the HEp-2 cells are genetically manipulated, the repertoire of autoantibodies that can be detected can be expanded.

In stage 2 of the present method, substrate cells, such as HEp-2 cells, are incubated with serially diluted patient samples then with a fluorescently labeled anti-human antibody, e.g., an anti-human IgG. By using an imaging flow cytometer, a variety of fluorescent-conjugated antibodies directed against specific cellular compartments or specific IgG isotypes can be used in this step of the method. Immediately preceding image acquisition, reagents for staining one or more cellular compartments or markers is added to the cellular sample. Advantageously, the detection of multiple cellular compartments or markers (e.g., DRAQ5 as a nuclear stain) and isotype-specific antibodies simultaneously, in a single reaction, allows for more accurate localization of antigens to a particular cell compartment, thereby providing more detailed information on the identities of specific autoantigens.

In stage 3 of the present method, the cells are subjected to imaging flow cytometry, thereby eliminating the use of microscopic slides and subjective evaluation. The samples acquired and cellular images captured with imaging flow cytometry are analyzed by image processing software such as IDEAS® (Amnis Corporation). Imaging flow cytometry is an instrument that combines microscopic technology with flow cytometry. High resolution images of large numbers of individually stained cells are autofocused and digitally captured. Raw image files of individual cells are then compensated by fluorescent stains used in stage 2. Data files are loaded into a pre-defined template that outputs the final IIF pattern results. This template, which provides the basis of the analytical power of the instant method, was developed using Center for Disease Control (CDC) reference sera that gives distinct IIF patterns on HEp-2 cells (Smolen, et al. (1997) Arthritis & Rheum. 40:413-418; Tan (1993) Manual of Biol. Markers of Disease A1:1-5).

Based on the cellular stains used in stage 2, specific populations of stained cells are then selected by gating for downstream analysis. A combination of image masks and features are used to define specific IIF patterns on selected populations of cells. For example, a centromeric ANA pattern would be detected using a spot mask and spot count feature. The software outputs a statistical report that defines the pattern and autoantibody titer of the clinical sample being assayed. The advantages of this method over those currently available are most apparent at this stage.

Overall, the method of this invention provides high-speed analysis of large quantities of clinical samples. It has the ability to rapidly select well-focused images of sufficient clinical quality for the purposes of diagnosis. Moreover, assay standardization can easily be performed by using an imaging flow cytometer to perform internal calibration. Using the instant method, subjective error is eliminated by processing large numbers of cell events per sample, while providing fully automated pattern recognition. This method provides the enhanced ability to localize autoantibody targets by digitally identifying cellular landmarks using stains in stage 2.

Accordingly, this invention is a method for detecting and identifying autoantibodies in a clinical sample, which includes the steps of incubating a patient sample with a suspension of fixed and permeabilized substrate cells; incubating the fixed suspension of substrate cells with a fluorescently labeled anti-human antibody; incubating the cells with a reagent for staining a cellular compartment or marker; subjecting the cells to imaging flow cytometry to acquire cellular images; and comparing the images to pre-defined templates with automated pattern recognition.

Substrate cells of the method are defined as cells that express one or more autoantigens, which can be bound by one or more respective autoantibodies in a patient sample. A variety of substrate cells can be used in accordance with the instant method including, but not limited to, isolated epithelial cells, cell lines, leukocytes, homogenized tissue sections, and primary cells from patients. In certain embodiments, the substrate cells are human epithelial cells. In particular embodiments, the substrate cells are HEp-2 cells. As is conventional in the art, HEp-2 cells are known substrates for ANA tests. These cells are described in the art (Moore, et al. (1955) Cancer Res. 15:598-602; Chen (1988) Cytogenet. Cell Genet. 48:19-24) and available from commercial sources such as ATCC (ATCC Number CCL-23). Substrate cells can be grown in Eagle's Minimum Essential Medium with 10% fetal bovine serum as either a suspension or as adherent cultures. However, when used in accordance with the instant method, the substrate cells are provided as a cell suspension, i.e., without being attached to a surface.

In some embodiments, the substrate cells are chemically and/or recombinantly manipulated to facilitate autoantibody detection and identification. Chemical manipulation of substrate cells includes, but is not limited to, the use of cell cycle arrest inducers such as colcemid, nocodazole, vincristine or cytochalasin. Recombinant manipulation of substrate cells is generally used to express one or more autoantigens thereby facilitating or enhancing the detection of autoantibodies to the same. Particular autoantigens that can be recombinantly expressed by substrate cells include, but are not limited to, Ro/SSA or La/SS-B. Recombinant protein expression is routinely carried out in the art and commercially available vectors and transfection reagents can be used to recombinantly manipulate substrate cells in accordance with the instant method.

To facilitate analysis, the substrate cells are fixed and permeabilized. There are two main types of fixatives: protein precipitants/coagulants and cross-linking agents. Alcohols and acetone are precipitating or coagulating fixatives. Traditional cross-linking fixatives include the aldehydes such as formaldehyde and glutaraldehyde, and carbodiimide cross-linking reagents. Agents for permeabilizing cells are well known in the art, and any suitable agent can be employed. Examples of agents for permeabilizing cells include, but are not limited to, TRITON X-100, saponin, and TWEEN-20 (Jamur & Oliver (2010) Methods Mol. Biol. 588:63-6).

After fixation and permeabilization, the suspension of substrate cells is incubated with the patient sample. Patient samples that can analyzed in accordance with the instant method include, but are not limited to, body fluid samples such as blood, plasma, serum, urine, sputum, cerebrospinal fluid, milk, or ductal fluid samples; or tissue samples such as biopsy samples. Samples may be removed surgically, by extraction, i.e., by hypodermic or other types of needles, by microdissection or laser capture. In particular embodiments, the suspension of substrate cells is incubated with a patient sample that has been serially diluted. After contacting the substrate cells with the patient sample, the cells are washed.

Subsequently, the substrate cells are incubated with one or more fluorescently labeled anti-human antibodies to detect one or more autoantibodies in the patient sample. While autoantibodies are primarily IgG antibodies, IgA and IgM autoantibodies may also be detected (Barnett, et al. (1965) Ann. Intern. Med. 63:100). Accordingly, the anti-human antibody can be isotype specific and bind to IgG, IgA or IgM autoantibodies. The anti-human antibody, also referred to as secondary antibodies, can be labeled with any suitable fluorophore or fluorochrome having the ability to absorb energy from incident light and emit the energy as light of a longer wavelength and lower energy. Fluorescein and rhodamine, usually in the form of isothiocyanates that can be readily coupled to antibodies, are most commonly used in the art (Stites, et al. (1994) Basic and Clinical Immunology). Fluorescein absorbs light of 490 nm to 495 nm in wavelength and emits light at 520 nm in wavelength. Tetramethylrhodamine absorbs light of 550 nm in wavelength and emits light at 580 nm in wavelength. When the instant assay is used to simultaneously detect more than one isotype, each isotype-specific secondary antibody can be labeled with a unique fluorescent label that emits light at a unique wavelength so that each secondary antibody can be individually identified.

To facilitate localization of binding of the autoantibody to autoantigens, the substrate cells are also incubated with a reagent for staining one or more cellular compartments or markers associate therewith. For example, nuclear staining can be achieved with DRAQ5 or CYTRAK ORANGE, both of which are anthraquinone dyes with high affinity for double-stranded DNA. Cell membrane dyes include CELLVUE Jade or Lavender, which contain long aliphatic hydrocarbon tails that incorporate into lipid membranes. Cytoplasmic proteins can be stained with 5-(and 6)-carboxyfluorescein diacetate succinimidyl ester, the succinimidyl ester group of which reacts with primary amines, crosslinking the dye to intracellular proteins. Mitochondria can be stained with MITOLITE Green and Rhodamine 123; lysosomes can be stained with LYSOLITE Red, neutral red, and N-(3-[2,4-dinitrophenyl amino] propyl)-N-(3-aminopropyl)methylamine (DAMP); and tetramethylrhodamine methyl ester (TMRM), tetramethylrhodamine ethyl ester (TMRE) and carbocyanine dyes can be used to label the endoplasmic reticulum. In addition to staining with dyes, the staining of proteins that are markers for particular cellular compartments is also contemplated. The staining of marker proteins can be achieved with antibodies specific for such proteins. Marker proteins include, but are not limited to, VDAC or TOMM22, which are localized to the outer membrane of the mitochondria; UPC1, UPC2, UPC3 or prohibitin, which are localized to the inner membrane of the mitochondria; ERp75, ERp72, glucosidase II, Grp78, Hsp25, or membrin, which are proteins localized to the lumen of the endoplasmic reticulum; Rbet1, calreticulin, calnexin, or P450, which are proteins localized to the membrane of the endoplasmic reticulum; Lap1, Lap2, c-Jun, NF kappa B, or histone, which are proteins localized to the nucleus; fibrillarin, which is a nucleolar marker protein; and TNF-R1, FADD, Grb2, Cadherin or Pma1, which are proteins localized to the plasma membrane.

Once labeled, the cells are washed and subjected to imaging flow cytometry to acquire cellular images. As an optional step, the cells can be fixed again before processing in the imaging flow cytometer. Imaging flow cytometry combines the statistical power and fluorescence sensitivity of standard flow cytometry with the spatial resolution and quantitative morphology of digital microscopy. In particular embodiments, extended depth of field (EDF) imaging is used (see, e.g., Ortyn, et al. (2007) Cytometry Part A &1A:215-231). Use of EDF in the method of this invention was found to improve precision, enhance discrimination, simplify analysis, increase resolution, and reduce acquisition time without having an effect on determining ANA positivity.

The multispectral/multimodal imagery collected by imaging flow cytometry, e.g., an Amnis Imagestream instrument, is then analyzed to automatically classify the cells. In accordance with the instant invention, the cells are classified by comparing the images obtained by imaging flow cytometry to pre-defined templates and automated pattern recognition software. Based upon pattern similarities, i.e., the topographic distribution of the autoantigens (in different cell compartments), the particular autoantigen is identified and a disease diagnosis or prognosis can be made. For example, a homogeneous nuclear pattern correlates with autoantibodies to DNA structures. Other examples of patterns in the ANA-HEp-2 test include, but are not limited to, nuclear speckled, nuclear centromeric, nucleolar, cytoplasmic, and the like. See Example 2.

Using the present assay, both end-titer determination and autoantibody IIF patterns in a patient can be determined. For end-titer determination, serially diluted samples are processed individually, and an identifier such as a bar code can be used to read multiple samples in one acquisition. In this respect, the method finds application as a diagnostic and/or prognostic tool for evaluating a wide spectrum of autoimmune diseases including, but not limited to, systemic lupus erythematosus (SLE), drug-induced SLE, autoimmune hepatitis, rheumatoid arthritis, polymyositis/dermatomyositis, Sharp syndrome, mixed connective tissue disease, Sjogren's syndrome, systemic sclerosis, scleroderma, discoid lupus, idiopathic thrombocytopenic purpura, fibromyalgia, and Raynaud's phenomenon. Other disorders such as chronic nutritive toxic liver disease and primary biliary cirrhosis have characteristic ANA expression and therefore the method can be used in the diagnosis or prognosis as well.

In addition to a method for detecting and identifying autoantibodies in a clinical sample, the present invention also provides a kit for carrying out the method. The kit of the invention includes fixed HEp-2 cells; one or more reagents for staining a cellular compartment or marker; one or more anti-human antibodies; and automated pattern recognition software for comparing imaging flow cytometry images to pre-defined templates of the various patterns known to be associated with particular autoantigens. In addition, the kit can include calibration beads, quality controls, and instructions for carrying out the claimed method.

The invention is described in greater detail by the following non-limiting examples.

### Example 1

### ANA Protocol

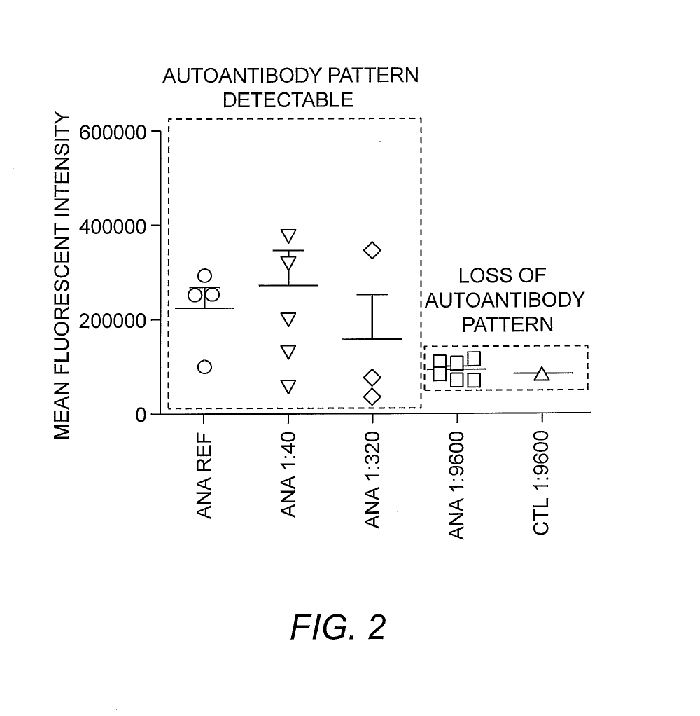

Patient samples are prepared at an appropriate dilution in phosphate buffered sample (PBS; e.g., 10 μL of sample plus 390 μL of PBS). Subsequently, the patient sample is incubated with a fixed and permeabilized suspension of HEp-2 cells. After an appropriate amount of time for the autoantibodies to bind autoantigens, the HEp-2 cells are incubated with fluorescent markers for cellular compartments and multiple serial dilutions can be prepared to determine titer. Generally, titers of 1:40 or less (e.g., in the range of 1:40 to 1:320) are particularly useful, and, as shown in FIG. 2, provide a sufficient level of intensity for autoantibody pattern detection.

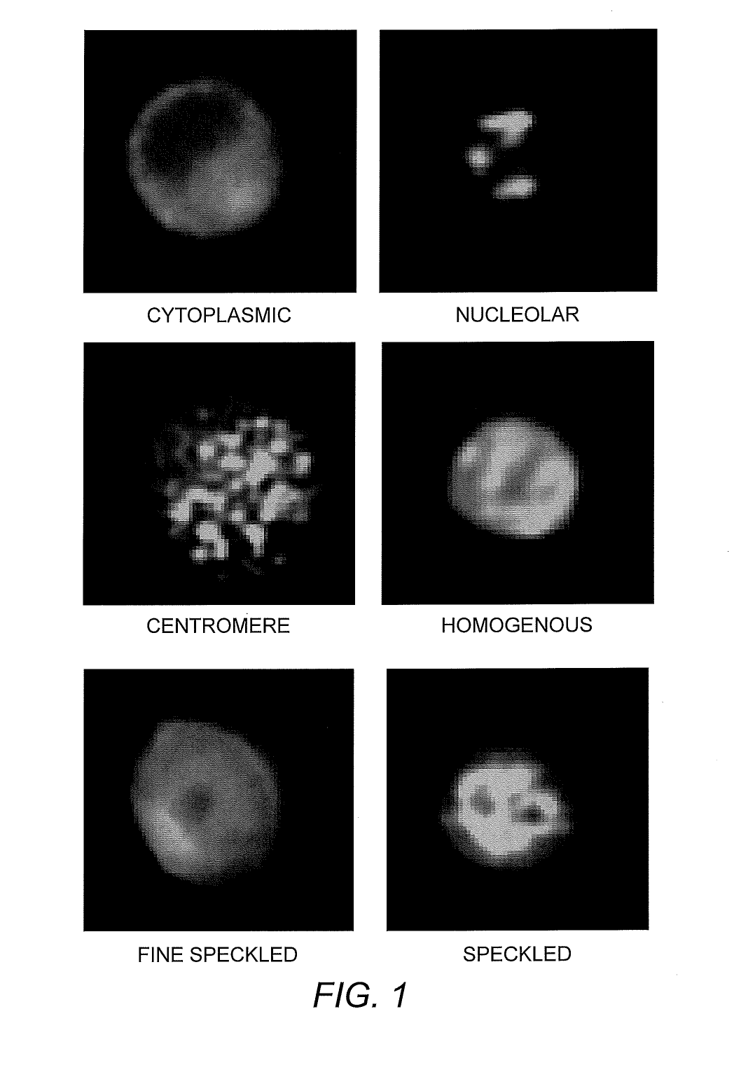

HEp-2 cells are subsequently incubated with fluorescent anti-IgG secondary antibody and localization of autoantibodies to cell compartments is carried out with imaging flow cytometry. Cellular images are captured and analyzed with pre-defined templates and software algorithms. A statistical report indicates pattern and titer. Combinations of image masks and features define distinct ANA patterns. Examples of such patterns are illustrated in FIG. 1.

### Example 2

### Classification of Patterns

Various patterns of autoantibody binding and the basis thereof are as follow:

### Nuclear Patterns

1. Homogeneous. A homogeneous or diffuse staining pattern of the nucleus is consistent with autoantibodies to native DNA (nDNA) histones and/or deoxyribonucleoprotein (DNP) (Lachman & Kunkel (1961) Lancet 2:436; Friou (1964) Arthritis Rheum. 7:161).

2. Speckled Patterns. A speckled pattern is the most commonly observed ANA pattern and can be distinguished from a homogenous pattern by, e.g., dark spot areas or areas of increased contrast. A uniform, true speckled pattern may be seen with centromere antibodies in cells not in division. A clumpy speckled patterns may be seen with antibodies to n-RNP, Sm, and SSB/La.
i. Fine speckled pattern, chromosome-negative: Numerous small uniform points of fluorescence uniformly scattered throughout the nucleus. The nucleoli generally appear unstained. The mitotic cells may demonstrate a few speckles in their cytoplasm, but the chromosomes are negative.
ii. Course speckled pattern, chromosome-negative: Medium-sized points of fluorescence are scattered throughout the nuclei with distinct nuclear margins. Larger-sized points of fluorescence may also be observed; however, they are too numerous and variable in size to be identified as a nucleolar pattern. The chromosomes in the mitotic cell are negative.
iii. Discrete speckled, chromosome (centromere specificity) positive: The chromosomes are positive in mitotic cells; in fact, the discrete speckles are only be clustered in the chromosome mass clearly demonstrating the various stages of mitosis. The centromere pattern has been recognized to be associated with the CREST syndrome, which is a milder variant of progressive systemic sclerosis (PSS). The centromere pattern demonstrates discrete and uniform points of fluorescent speckles scattered throughout the nucleus. Mitotic cells are positive, demonstrating a clustering of the centromeres in the chromosomes in different arrangements according to the mitotic stage. It has been demonstrated that serum samples containing highly monospecific anti-SSA/Ro gave an IF-ANA test pattern of discrete nuclear speckles on a wide variety of human cells and tumor nuclei (Alarcon-Segovia & Fishbein (1975) J. Rheum. 2:167). Such serum samples with monospecific anti-SSA/Ro produced very little cytosplasmic staining of substrate cells. A distinct, large, variable speckled pattern of 3 to 10 large speckles in the nucleus has been described. These patients with large, variable speckles have undifferentiated rheumatic disease syndromes with IgM antihistone H-3 antibody (Peebles, et al. (1984) Arthritis Theum. 27:S44).

3. Nucleolar Pattern. The nucleolar pattern demonstrates a homogeneous speckled staining of the nucleolus. This pattern is often associated with a dull, homogeneous fluorescence in the rest of the nucleus. The chromosomes in the mitotic cells are negative. The nucleolar pattern suggests autoantibodies to 4-6S RNA. The nucleolar fluorescence appears as homogeneous, clumped, or speckled, depending on the antigen to which the autoantibody reacts. Antinucleolar antibodies occur primarily in the sera of patients with scleroderma, systemic lupus erythematosus, Sjögren's syndrome, or Raynaud's phenomenon (Ritchie (1970) N. Engl. J. Med. 282:1174-1178).

4. Peripheral (Rim). The nuclei stain predominantly at their periphery. The chromosomes of the mitotic cells stain as irregularly shaped masses with more intensely stained outer edges. This pattern is often seen with autoantibodies to nDNA (Casals, et al. (1964) Arthritis Rheum. 7:379; Beck (1963) Scott. Med. J. 8:373; Anderson, et al. (1962) Ann. Rheum. Dis. 21:360; Luciano & Rothfield (1973) Ann. Rheum. Dis. 32:337). If the chromosomes of the mitotic cells are negative, then the pattern would be suggestive of autoantibodies to the nuclear membrane and not to nDAN, and not reported as a peripheral pattern.

5. Additional Patterns.
i. Spindle fiber pattern, chromosome-positive: The spindle fiber pattern is unique to cells undergoing mitosis where only the spindle apparatus fluoresces. This pattern has a “spider web” appearance extending from the centriole to the centromeres. The pattern is suggestive of autoantibodies to the microtubules and its significance is unclear; however, an association between the spindle fiber pattern and carpal tunnel syndrome has been suggested.
ii. Midbody pattern: The midbody pattern is a densely staining region near the cleavage furrow of telophase cells, that is, in the area where the two daughter cells separate. The clinical significance of the pattern is unknown; however, the pattern has been recognized in selected patients with systemic sclerosis.
iii. Centriole pattern: The centiole pattern is characterized by two distinct points of fluorescence in the nucleus of the mitotic cells or one distinct point of fluorescence in the resting cell. The significance of this pattern in not known; however, it has been observed in PSs.
iv. Proliferating cell nuclear antigen (PCNA) pattern: The proliferating cell nuclear antigen pattern is observed as a fine-to-course nuclear speckling in 30-60% of the cells in interphase, and a negative staining of the chromosome region of mitotic cells. The PCNA is very specific for patients with SLE but not detected in other connective tissue disease disorders. It has been reported that SLE patients with the PCNA pattern have a higher incidence of diffuse glomerulonephritis.
v. Antinuclear membrane (nuclear laminae): The antinuclear membrane pattern appears as a rim around the nucleus and resembles a rim pattern; however, it is distinguished from the rim pattern by the fact that the metaphase chromosome stage is negative. This autoantibody is important to report because it has been recognized to be associated with autoimmune liver disease.

### Cytoplasmic Patterns.

1. Mitochondrial (AMA) pattern: The pattern characteristically has numerous cytoplasmic speckles with the highest concentration in the perinuclear area. The pattern can be observed in interphase and mitotic cells. The clinical significance of AMA is most frequently an association with primary biliary cirrhosis, especially when the AMA is a high titer.

2. Golgi apparatus pattern: The golgi apparatus pattern is characterized by positive cytoplasmic staining that is concentrated on only one side of the perinuclear region. The clinical significance is uncertain, but this pattern has been suggested to have an association with SLE and Sjogren's Syndrome.

3. Lysosomal pattern: The lysosomal pattern is observed as a few discrete speckles sparsely spaced throughout the cytoplasm. The pattern is observed in the cytoplasm of interphase and mitotic cells. The clinical significance has not been identified.

4. Ribosomal pattern: The ribsosomal pattern is characterized by numerous cytoplasmic speckles with the highest concentration around the nucleus. It is distinguished from the mitochondrial pattern because of the smaller specks and higher density. The significance of the patter has not been identified.

5. Cytoskeletal pattern: The cytoskeletal pattern is characterized by a distinct “spider web” or fibrous appearance throughout the cell. It has been reported to be associated with autoimmune liver disease (anti-smooth muscle).

ANA Negative.

Autoantibody to SSA/Ro is present in high frequency in a clinical subset of lupus called subacute cutaneous lupus erythematosus (SCLE). Many patients with SCLE have been falsely labeled as having “ANA-negative” lupus. However, many of these so-called “ANA-negative” LE patients will demonstrate a positive IF-ANA on substrate of HEp-2 cells containing the SS/Ro antigen (Deng, et al. (1984) J. Am. Acad. Dermatol. 11:494-499). Anti-SSA/Ro antibodies may be present in the absence of traditional ANAs, with SLE seen in persons genetically deficient in C4 and occasionally other complementary deficiencies (Meyer, et al. (1985) Clin. Exp. Immunol. 62:678-684; Provost, et al. (1983) Arthritis Rheum. 26:1279-1282). In addition, C4 deficiency may be associated with increased susceptibility to development of SLE upon treatment with hydralazine (Speirs, et al. (1989) Lancet 1:922-924).

Although the level of ANA may not correlate with the clinical course of a particular autoimmune disease state (Dubois (1975) J. Rheum. 2:204), the various patterns of nuclear staining may be associated with specific disease states (Casals, et al. (1964) supra; Luciano & Rothfield (1973) supra; Hall, et al. (1960) N. Engl. J. Med. 263:769; Raskin (1964) J. Arch. Derm. 89:569; Beck, et al. (1963) Lancet 2:1188).

As indicated, there are particular autoantibodies (and staining patterns thereof) associated with particular disease states. These autoantibodies include, but are not limited to anti-Jo-1 (directed at histidyl-tRNA ligase), anti-SM (directed to core proteins of snRNPs), anti-dsDNA (directed at DNA), anti-histone (directed at histones), anti-Scl-70 (directed at type I topoisomerase), anti-snRNP70 (directed at snRNP70), and SS-A (Ro) and SS-B (La) (directed at RNPs), anti-gp-210 (directed at nuclear pore gp-210), anti-p62 (directed at nucleoporin 62), and anti-centromere autoantibodies.

The following table summarizes the various autoantibodies noted above with respect to disease association.

TABLE 1

| | | Relative Frequency of |
|---|---|---|
| Autoantibody | Disease State | Autoantibody Detection (%) |
| Anti-Jo-1 | Myositis | 24-44 |
| Anti-SM | SLE | 30* |
| Anti-RNP | MCTD, SLE | 100** and >40, |
| | | respectively |
| Anti-SSA/Ro | SLE, Sjogren's | 15 and 30-40, respectively |
| Anti-SSBLa | SLE, Sjogren's | 15 and 60-70, respectively |
| Anti-Scl-70 | Systemic sclerosis | 20-28* |

*Highly specific;
**Highly specific when present alone at high titer.

What is claimed is:

1. A method for detecting and identifying autoantibodies in a clinical sample comprising
(a) fixing and permeabilizing a suspension of substrate cells;
(b) incubating a patient sample with the suspension of substrate cells;
(c) incubating the suspension of substrate cells with a fluorescently labeled anti-human antibody;
(d) incubating the substrate cells with a reagent for staining a cellular compartment or marker;
(e) subjecting the substrate cells to imaging flow cytometry to acquire cellular images; and
(f) comparing the images to pre-defined templates with automated pattern recognition to detect and identify autoantibodies.

2. The method of claim 1, wherein the anti-human antibody is an anti-human IgG antibody, anti-human IgA antibody or anti-human IgM antibody.

3. The method of claim 1, wherein the substrate cells have been chemically or recombinantly manipulated.

4. The method of claim 1, wherein the substrate cells are human epithelial-2 (HEp-2) cells.

5. A kit comprising
(a) fixed HEp-2 cells;
(b) one or more reagents for staining a cellular compartment or marker;
(c) one or more anti-human antibodies; and
(d) automated pattern recognition software for comparing imaging flow cytometry images to pre-defined templates.
